(19) United States
(12) Patent Application Publication
(10) Pub. No.: US 2013/0141894 A1
(43) Pub. Date: Jun. 6, 2013

(54) Slim Bezel Backlight Module of Liquid Crystal Display Device

(71) Applicants: Yajun Yu, Shenzhen (CN); Gang Yu, Shenzhen (CN)

(72) Inventors: Yajun Yu, Shenzhen (CN); Gang Yu, Shenzhen (CN)

(73) Assignee: Shenzhen China Star Optoelectronics Technology Co. LTD., Shenzhen, Guangdong (CN)

(21) Appl. No.: 13/381,939

(22) PCT Filed: Dec. 5, 2011
(86) PCT No.: PCT/CN2011/083444

§ 371 Date: Dec. 31, 2011

(30) Foreign Application Priority Data
Dec. 1, 2011 (CN) 201110393440.4

(51) Int. Cl. G09F 13/04

(52) U.S. Cl. 362/97.2

(57) ABSTRACT

The present invention provides a slim bezel backlight module of liquid crystal display device, which includes: a bezel, a back panel, a connection member, and a plastic frame arranged on the back panel. The bezel includes a front plate that forms a displaying opening and a side plate extending downward from one end of the front plate. The back panel includes a bottom board that is opposite to the front plate. The front plate of the bezel forms a first through hole. The plastic frame forms a through hole corresponding to the first through hole. The bottom board of the back panel forms a second through hole corresponding to the first through hole. The connection device includes a connection member and a locking member mating the connection member. The connection member includes a base section and an extension section extending downward from the base section. The base section is riveted in the first through hole in such a way that a free end face of the base is lower than or flush with an upper surface of the front plate. The extension section extends through the through hole and runs through the second through hole to engage the locking member. The locking member is positioned against the bottom board of the back panel to thereby fix the bezel to the back panel.

### BACKGROUND OF THE INVENTION

1. Field of the Invention

The present invention relates to the technical field of TFT-LCD liquid crystal displaying, and in particular to a slim bezel backlight module of a liquid crystal display device.

2. The Related Arts

Due to the advantageous features of low power consumption and low radiation, liquid crystal display devices are now widely used in the current displaying equipments. With the continuous progress of the liquid crystal technology, liquid crystal display devices that are made large in size and slim in configuration are becoming the main stream of market. A liquid crystal display device generally comprises a liquid crystal panel and a backlight module. The structure of the backlight module determines, to quite an extent, the enlarging of size and the sliming of configuration for the liquid crystal display device. Consequently, bezel sliming of the backlight module is now a trend. A backlight module generally comprises a bezel, a back panel connected to and mating the bezel, a plastic frame and a light guide plate positioned on the back panel, and an optic film positioned on the light guide plate. The bezel comprises a front plate that forms a displaying opening and a side plate extending downward from one side of the front plate. The liquid crystal panel is positioned on the backlight module and corresponds to the displaying opening of the front plate. Due to bezel sliming of the backlight module, the width of the front plate of the bezel is narrowed and the thickness thinned, all these making it no longer possible for the front plate of the bezel to provide a space for accommodating a nut. Since it does not allow the nut to project beyond the surface of the bezel, it is not possible to apply screw fixing to the front plate of the bezel.

To overcome such a problem, for the known liquid crystal display device, a solution to apply screw fixing to the slim bezel backlight module of the liquid crystal display device is to press a threaded counterbore hole in the side plate of the bezel and a bolt is used to secure to the back plane. Such a fixing arrangement requires formation of a plurality of bumps on the back panel to mate the counterbore bump feature of the bezel for screwing. They occupy a great amount of space of the back panel and are thus adverse to formation of other feature on the bump sites of the back panel. Further, to avoid position interference, the plastic frame must be hollowed at the locations corresponding to the bumps of the back panel and the bezel. This greatly reduces the structural strength of the whole plastic frame.

### SUMMARY OF THE INVENTION

An objective of the present invention is to provide a slim bezel backlight module of liquid crystal display device, which saves space, shows high structural strength, and is helpful in sliming the bezel.

To achieve the objective, the present invention provides a slim bezel backlight module of liquid crystal display device, which comprises: a bezel, a back panel, a connection member, and a plastic frame arranged on the back panel. The bezel comprises a front plate that forms a displaying opening and a side plate extending downward from one end of the front plate. The back panel comprises a bottom board that is opposite to the front plate. The front plate of the bezel forms a first through hole. The plastic frame forms a through hole corresponding to the first through hole. The bottom board of the back panel forms a second through hole corresponding to the first through hole. The connection device comprises a connection member and a locking member mating the connection member. The connection member comprises a base section and an extension section extending downward from the base section. The base section is riveted in the first through hole in such a way that a free end face of the base is lower than or flush with an upper surface of the front plate. The extension section extends through the through hole and runs through the second through hole to engage the locking member. The locking member is positioned against the bottom board of the back panel to thereby fix the bezel to the back panel.

The locking member is a bolt and the extension section of the connection member has a free end forming a threaded hole mating the bolt. The locking member extends through the second through hole to threadingly engage the threaded hole.

The locking member is a nut and the extension section of the connection member having a free end forming an external thread mating the nut. The extension section extends through the second through hole to engage the nut.

The locking member comprises a retention section and an extension-through section connected to the retention section. The extension-through section has a free end forming a threaded hole. The extension section of the connection member has a free end forming an external thread mating the threaded hole. The extension-through section extends through the second through hole to allow the threaded hole thereof to threadingly engage the external thread of the extension section of the connection member, the retention section being positioned against the bottom board of the back panel.

The retention section of the locking member has a side surface forming anti-skidding patterns.

A light guide plate is further included and arranged on the back panel and an optic film arranged on the light guide plate.

The back panel comprises a side board extending upward from an end of the bottom board. The plastic frame is arranged between the bezel and the back panel. The side plate of the bezel is located outside the side board of the back panel.

The efficacy of the present invention is that the present invention provides a slim bezel backlight module of liquid crystal display device that securely fixes the bezel to the front plate of the back panel by riveting the connection member to the front plate of the bezel and ensuring the flatness of the front surface of the bezel, so that, as compared to the conventionally adopted side surface fixing arrangement, a great amount of space and sites on the plastic frame and the back panel is saved and removal of material in a large area of the plastic frame for not interfering with the bumps of the bezel and the bumps of the back panel is avoided, thereby guaranteeing the structural strength of the plastic frame and helping the sliming of the bezel for the backlight module.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, will be apparent from the following detailed description of an embodiment of the present invention, with reference to the attached drawings. In the drawings:

FIG. 1 is a partial sectioned view of a slim bezel backlight module of liquid crystal display device according to a first embodiment of the present invention;

FIG. 2 is an exploded view of a connection device shown in FIG. 1;

FIG. 3 is a partial sectioned view of a slim bezel backlight module of liquid crystal display device according to a second embodiment of the present invention;

FIG. 4 is a partial sectioned view of a slim bezel backlight module of liquid crystal display device according to a third embodiment of the present invention; and

FIG. 5 is a schematic view illustrating a locking member of FIG. 4.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

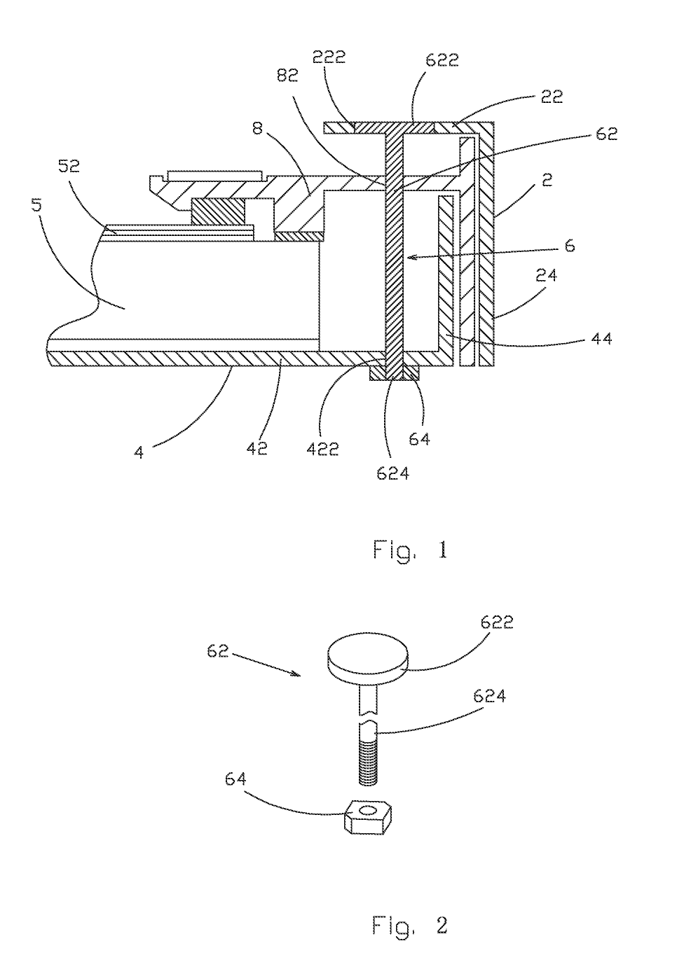

As shown in FIGS. 1-2, a slim bezel backlight module of liquid crystal display device according to a first embodiment of the present invention is shown, which comprises: a bezel 2, a back panel 4, a light guide plate 5 arranged on the back panel 4, an optic film 52 arranged on the light guide plate 5, a connection device 6, and a plastic frame 8 arranged on the back panel 4. The connection device 6 fixes the bezel 2 to a front plate of the back panel 4.

The bezel 2 comprises a front plate 22 that forms a displaying opening and a side plate 24 extending downward from an end of the front plate. The front plate 22 forms a first through hole 222. The first through hole 222 fixes the connection device 6.

The back panel 4 comprises a bottom board 42 opposite to the front plate 22 and a side board 44 extending upward from an end of the bottom board 42. The plastic frame 8 is mounted between the bezel 2 and the back panel 4. The bezel side plate 24 is arranged outside the back panel side board 44. The bottom board 42 forms a second through hole 422 corresponding to the first through hole 222 formed in the front plate 22 of the bezel 2. The plastic frame 8 forms a through hole 82 corresponding to the first through hole 222 formed in the bottom board 42 of the back panel 4. A connection member 62 has an extension section 624 extending through the through hole 82.

The connection device 6 comprises the connection member 62 and a locking member 64 mating the connection member 62. The connection member 62 comprises a base section 622 and the extension section 624 that extends outward from the base section 622. The base section 622 is riveted in the first through hole 222 of the front plate 22 of the bezel 2 to thereby fix the connection member 6 to the front panel 22 of the bezel 2 in such a way that after riveting, the base section 622 of the connection member 62 has an upper surface that is flush with or lower than an upper surface of the front plate 22 of the bezel 2 so as to ensure the surface of front plate of the bezel 2 is flat. The extension section 624 of the connection member 62 mates the locking member 64 and the locking member 64 is positioned against the bottom board 42 of the back panel to secure the bezel 2 and the back panel 4 together.

In the instant embodiment, the locking member 64 is a nut and the extension section 624 of the connection member 62 has a free end that forming an external thread corresponding to the locking member 64. The extension section 624 extends through the second through hole 422 to engage the nut.

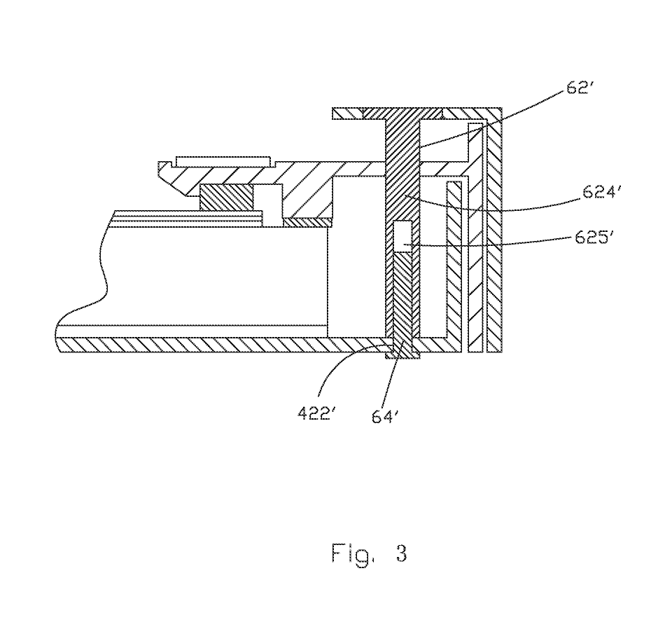

As shown in FIG. 3, a slim bezel backlight module of liquid crystal display device according to a second embodiment of the present invention is shown, which is different from the first embodiment in that: the locking member 64′ is a flat head bolt and the extension section 624′ of the connection member 62′ has a free end forming a threaded hole 625′ corresponding to the locking member 64′, whereby the locking member 64′ extends through the second through hole 422′ to threadingly engage the threaded hole 625′.

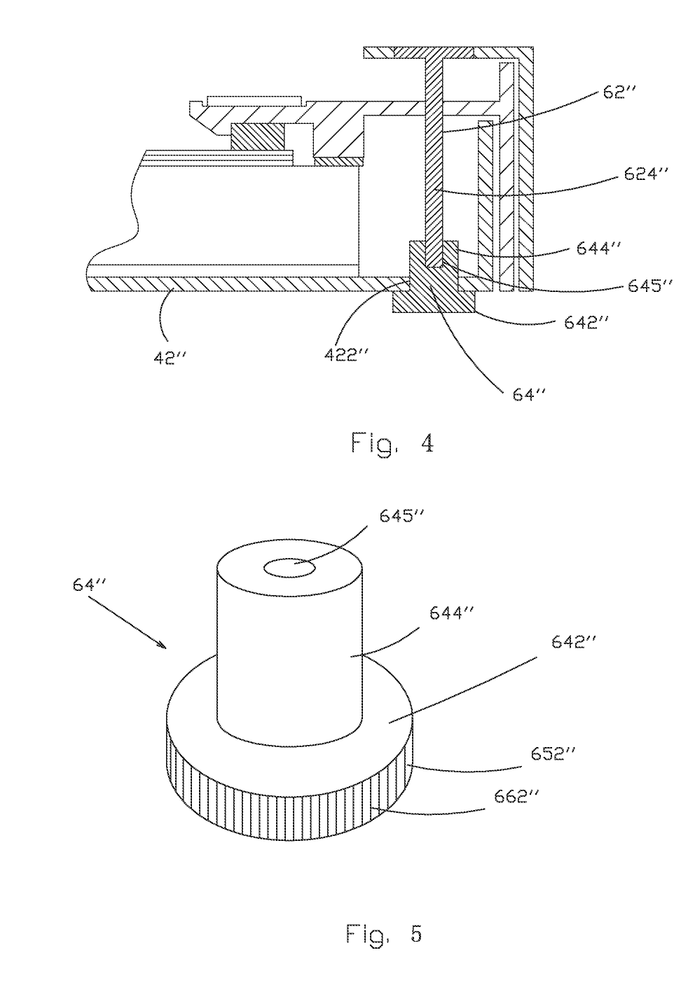

Referring to FIGS. 4-5, a slim bezel backlight module of liquid crystal display device according to a third embodiment of the present invention is shown, which is different from the first embodiment in that: the extension section 624″ of the connection member 62″ has a free end that forms an external thread. The locking member 64″ comprises a retention section 642″ and an extension-through section 644″ that is connected to the retention section 642″. The extension-through section 644″ has a free end forming a threaded hole 645″. The extension-through section 644″ extends through the second through hole 422″ and the threaded hole 645″ of the extension-through section 644″ threadingly engages the external thread of the extension section 624″ of the connection member 62″, whereby the retention section 642″ is positioned against the back panel bottom board 42″. The retention section 642″ has a side surface 652″ forming anti-skidding patterns 662″ for facilitating mounting and removal of the locking member 64″.

Further, the locking member 64 can alternatively be riveted to the bottom board of the back panel or integrally formed with the bottom board of the back panel to subsequently engage the connection member 62. Repeated description will be omitted.

In summary, the present invention provides a slim bezel backlight module of liquid crystal display device that securely fixes the bezel to the front plate of the back panel by riveting the connection member to the front plate of the bezel and ensuring the flatness of the front surface of the bezel, so that, as compared to the conventionally adopted side surface fixing arrangement, a great amount of space and sites on the plastic frame and the back panel is saved and removal of material in a large area of the plastic frame for not interfering with the bumps of the bezel and the bumps of the back panel is avoided, thereby guaranteeing the structural strength of the plastic frame and helping the sliming of the bezel for the backlight module.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A slim bezel backlight module of a liquid crystal display device, comprising a bezel, a back panel, a connection device, and a plastic frame arranged on the back panel, the bezel comprising a front plate that forms a displaying opening and a side plate extending downward from one end of the front plate, the back panel comprising a bottom board that is opposite to the front plate, the front plate of the bezel forming a first through hole, the plastic frame forming a through hole corresponding to the first through hole, the bottom board of the back panel forming a second through hole corresponding to the first through hole, the connection device comprising a connection member and a locking member mating the connection member, the connection member comprising a base section and an extension section extending downward from the base section, the base section being riveted in the first through hole in such a way that a free end face of the base is lower than or flush with an upper surface of the front plate, the extension section extending through the through hole and running through the second through hole to engage the locking member, and the locking member positioned against the bottom board of the back panel to thereby fix the bezel to the back panel.

2. The slim bezel backlight module of a liquid crystal display device as claimed in claim 1, wherein the locking member is a bolt and the extension section of the connection member has a free end forming a threaded hole mating the bolt, the locking member extending through the second through hole to threadingly engage the threaded hole.

3. The slim bezel backlight module of a liquid crystal display device as claimed in claim 1, wherein the locking member is a nut, the extension section of the connection member having a free end forming an external thread mating the nut, the extension section extending through the second through hole to engage the nut.

4. The slim bezel backlight module of a liquid crystal display device as claimed in claim 1, wherein the locking member comprises a retention section and an extension-through section connected to the retention section, the extension-through section having a free end forming a threaded hole, the extension section of the connection member having a free end forming an external thread mating the threaded hole, the extension-through section extending through the second through hole to allow the threaded hole thereof to threadingly engage the external thread of the extension section of the connection member, the retention section being positioned against the bottom board of the back panel.

5. The slim bezel backlight module of a liquid crystal display device as claimed in claim 4, wherein the retention section of the locking member has a side surface forming anti-skidding patterns.

6. The slim bezel backlight module of a liquid crystal display device as claimed in claim 1 further comprising a light guide plate arranged on the back panel and an optic film arranged on the light guide plate.

7. The slim bezel backlight module of a liquid crystal display device as claimed in claim 1, wherein the back panel comprises a side board extending upward from an end of the bottom board, the plastic frame being arranged between the bezel and the back panel, the side plate of the bezel being located outside the side board of the back panel.
